(19) United States
(12) Patent Application Publication
(10) Pub. No.: US 2014/0022734 A1
(43) Pub. Date: Jan. 23, 2014

(54) OPTICAL MODULE

(71) Applicant: OCLARO JAPAN, INC., Kanagawa (JP)

(72) Inventors: Osamu YAMADA, Hiratsuka (JP); Mitsuo AKASHI, Fujisawa (JP); Shinichi OKAYAMA, Hamamatsu (JP); Osamu KAGAYA, Tokyo (JP); Hiroyoshi ISHII, Yokohama (JP)

(21) Appl. No.: 13/909,319

(22) Filed: Jun. 4, 2013

(30) Foreign Application Priority Data
Jul. 17, 2012 (JP) 2012-158697

(51) Int. Cl. H04B 10/60

(52) U.S. Cl. CPC H04B 10/60
USPC 361/728

(57) ABSTRACT

An optical module includes: an optical receiving module 101 provided with a plurality of leads 105 for transmitting an electrical signal at 15 Gbit/s or more; a printed circuit board 103 provided with a pad 106 that is connected with the plurality of leads 105 by solder; and a metal thin plate 102 that is provided between the printed circuit board 103 and the optical receiving module 101 when the optical receiving module 101 is mounted on the printed circuit board 103. The thickness of the metal thin plate 102 is defined in such a manner that a distance between the plurality of leads 105 and the pad 106 is in the range of 50 to 500 μm after the optical receiving module. 101 is mounted on the printed circuit board 103.

### CROSS-REFERENCE TO RELATED APPLICATION

The present application claims priority from Japanese application JP2012-158697 filed on Jul. 17, 2012, the content of which is hereby incorporated by reference into this application.

### BACKGROUND OF THE INVENTION

1. Field of the Invention

The present invention relates to an optical module.

2. Description of the Related Art

An information transmission amount of an optical communication network grows steadily, and in particular for middle or long-distance transmission, transmission devices having a transmission speed of 40 Gbit/s, 100 Gbit/s are increasing. An optical module used for these transmission devices is demanded to be compact, consume less power, and cost less, and integration of such an optical module has been progressed. For example, a technique for making an optical module compact is described in JP 2008-28309 A.

For a receiving module used in an optical module, industrial standardization by OIF (Optical Internetworking Forum), which is an industry group, has been progressed. According to the standard, for example, the size of a receiving module of 40 Gbit/s or 100 Gbit/s is 45×27×8 mm, which is large. From the study of the inventors, a receiving module has a weight more than 10 g when a PKG is configured using kovar alloy in order to hold an optical element and an optical system inside thereof and to secure heat dispersion. A metal PKG (receiving module) of this type, which is comparatively large and has a comparatively large weight, is usually mounted on a printed circuit board using four screws in order that the PKG withstands mechanical vibration and impact force during transportation or during use, and heat dispersion from the PKG bottom surface to the printed circuit board is improved.

In order to transmit a signal received by a receiving module to the printed circuit board, a lead portion for extracting an electrical signal from the receiving module and an electrode pad of the printed circuit board are soldered. It is desirable that the shape of the lead portion is almost straight and a gap between the lead portion and the electrode pad is as small as possible in order to avoid deterioration of transmission characteristics of a high-frequency signal. For example, the thickness of the lead portion is about 0.15 mm, which is thin, and an interval (lead pitch) between leads in the lead portion is about 1 mm.

However, if the lead portion and the electrode pad are soldered when they are close enough not to leave a gap therebetween, a very thin portion is generated in the solder that connects the lead portion and the electrode pad. Then, there has been a case where a crack/disconnection is generated in the very thin portion of the solder in a given temperature cycling test, and thus transmission characteristics of a high-frequency signal is significantly deteriorated. Note that the given temperature cycling test is a test to be performed on an optical module obtained by soldering a receiving module on a printed circuit board, and it is required to pass 100 cycles, which is a target in the industry (based on a required value related to a temperature cycle for an optical integration module provided in Table 4-4 in 3.3.2.2 of Telcordia GR-468-CORE “Generic Reliability Assurance Requirements for Optoelectronic Devices Used in Telecommunications Equipment”) of the temperature cycling test.

The present invention is made in view of the above-described problems, and an object thereof is to provide an optical module which makes a crack/disconnection less likely occur in a connection portion between an optical receiving module and a printed circuit board.

### SUMMARY OF THE INVENTION

To achieve the above-described object, an optical module according to the present invention includes: an optical receiving module provided with a plurality of leads for transmitting an electrical signal at 15 Gbit/s or more; a printed circuit board provided with a pad that is connected with the plurality of leads by solder; and a metal thin plate that is provided between the printed circuit board and the optical receiving module when the optical receiving module is mounted on the printed circuit board, wherein a thickness of the metal thin plate is defined in such a manner that distance between the plurality of leads and the pad is in the range of 50 to 500 μm after the optical receiving module is mounted on the printed circuit board.

In an aspect of the present invention, in the optical module, the printed circuit board, the metal thin plate, and the optical receiving module may be fastened by a plurality of screws that are inserted through the printed circuit board, the metal thin plate, and the optical receiving module respectively, and the plurality of leads and the pad may be thereafter connected by the solder.

In an aspect of the present invention, in the optical module, the metal thin plate may have a surface of a shape that is substantially identical to a surface of the optical receiving module, the surfaces facing each other.

In an aspect of the present invention, in the optical module, the metal thin plate may be made of stainless steel.

In an aspect of the present invention, in the optical module, the plurality of leads may be provided near a bottom surface of the optical receiving module on a side surface thereof, and an area where the optical receiving module is mounted in the printed circuit board and the pad may be in an identical surface.

In an aspect of the present invention, in the optical module, the optical receiving module may include the plurality of leads that transmit an electrical signal at 20 Gbit/s or more, and the thickness of the metal thin plate may be defined in such a manner that a distance between the plurality of leads and the pad is 50 to 300 μm when the optical receiving module is mounted on the printed circuit board.

In an aspect of the present invention, in the optical module, the optical receiving module may include the plurality of leads that transmit an electrical signal at 30 Gbit/s or more, and the thickness of the metal thin plate may be defined in such a manner that a distance between the plurality of leads and the pad is 50 to 200 μm when the optical receiving module is mounted on the printed circuit board.

According to an aspect of the present invention, it is possible to make a crack/disconnection less likely occur in a connection portion between the optical receiving module and the printed circuit board.

### BRIEF DESCRIPTION OF THE DRAWINGS

FIG. 1 is a view illustrating one configuration example of an optical module according to a first embodiment;

FIG. 2 is a view for describing an assembled state of an optical receiving module, a printed circuit board, and upper and lower metal cases;

FIG. 3 is a side view of the optical receiving module according to the first embodiment;

FIG. 4 is a plan view of the optical receiving module according to the first embodiment;

FIG. 5 is a view showing a relationship between the thickness (μm) of a metal thin plate and the lifetime cycle (number of times) in a temperature cycling test;

FIG. 6 is a view showing a relationship between the thickness (μm) of the metal thin plate and the reflectance loss (dB) of the high-frequency transmission characteristics of the optical receiving module;

FIG. 7 is a side view of an optical module according to a second embodiment;

FIG. 8 is a side view of an optical module according to a third embodiment;

FIG. 9 is a plan view of the optical module according to the third embodiment;

FIG. 10 is a view illustrating a configuration example of a case where the optical receiving module is directly provided on a printed circuit board; and

FIG. 11 is a cross-section view of lead connecting solder in the configuration illustrated in FIG. 10.

### DETAILED DESCRIPTION OF THE INVENTION

Embodiments of the present invention will be hereinafter described referring to the accompanying drawings.

### First Embodiment

First, an optical module 100 according to a first embodiment will be described.

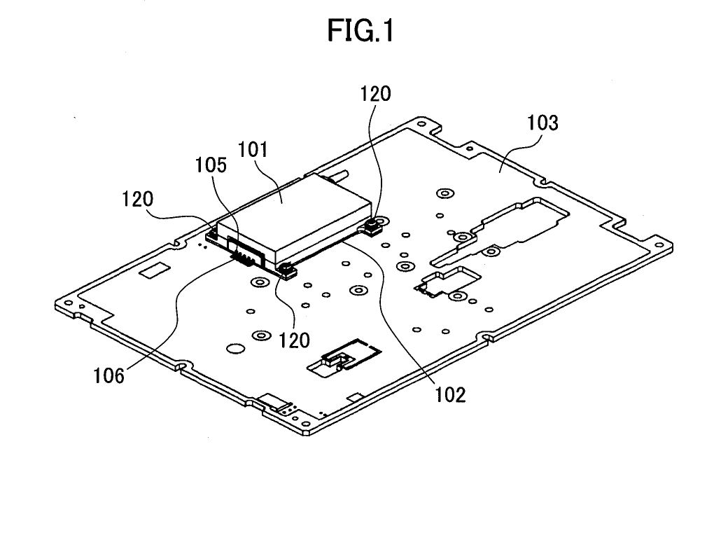

FIG. 1 is a view illustrating one configuration example of the optical module 100 according to this embodiment. In the configuration diagram of FIG. 1, only an optical receiving module 101 for receiving an optical signal and a printed circuit board 103 in the optical module 100 are illustrated for convenience of description, but other components such as various ICs, LCR components, connector components, laser modules are obviously provided on the optical module 100.

As illustrated in FIG. 1, the optical receiving module 101 is mounted on the printed circuit board 103 through a metal thin plate 102 using screws 120. Note that, leads 105 from the optical receiving module 101 are electrically connected using a pad (electrode pad) 106 of the printed circuit board 103 and solder.

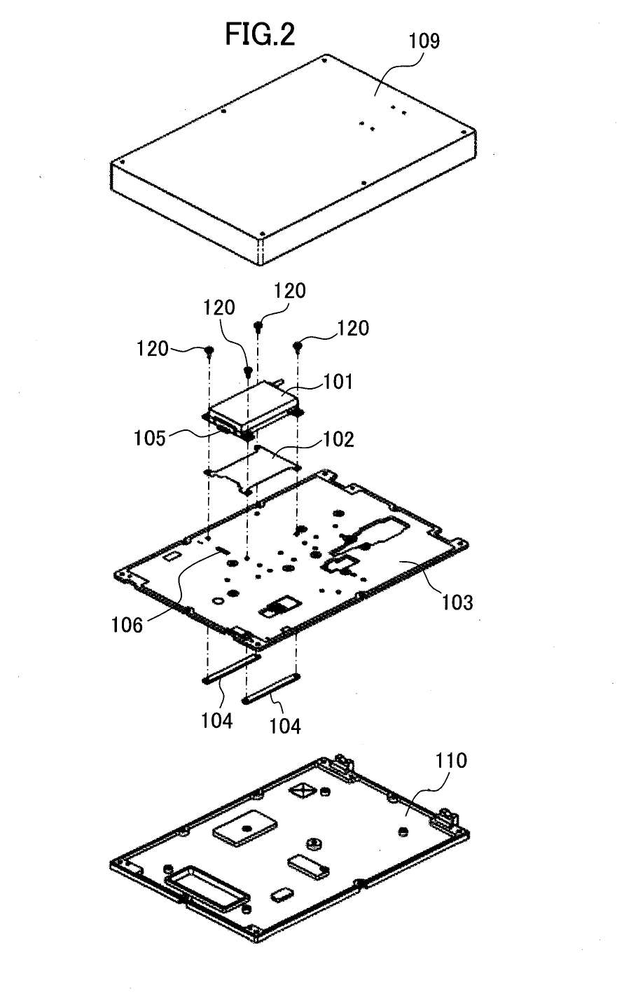

FIG. 2 illustrates a view for describing an assembled state of the optical receiving module 101, the printed circuit board 103, and upper and lower metal cases.

As illustrated in FIG. 2, the optical receiving module 101, the metal thin plate 102, and the printed circuit board 103 are stacked in this order, and four screws 120 are inserted from above through flange portions (hole portions) of the optical receiving module 101, flange portions (hole portions) of the metal thin plate 102, holes of the printed circuit board 103, and two screw plates 104 provided on the rear surface of the printed circuit board 103 so as to be fastened. Note that, the leads 105 that transmit a high-frequency signal received by the optical receiving module 101 to the printed circuit board 103 and a pad 106 provided on the printed circuit board 103 are connected using solder. The solder used herein may be solder having a Sn-3Ag-0.5Cu composition (solder having this composition will be referred to as solder A) that is typical for Pb free solder.

After a process of mounting the optical receiving module 101 on the printed circuit board 103 is performed, the printed circuit board 103 are sandwiched between an upper case 109 and a lower case 110 and fastened by screws so as to package the optical module 100.

In the optical module 100 illustrated in FIG. 1, optical components mounted on the printed circuit board 103 except for the receiving module, optical fibers connecting them, or the like are not illustrated for description. The optical components may include various ICs, LCR components, connector components, and laser modules. In addition, in the optical module 100 illustrated in FIG. 1, the upper case and the lower case made of metal such as aluminum alloy that are illustrated in FIG. 2 are not illustrated either. Note that the number and fastened positions of the above-described screws may be appropriately designed and mounted in such a manner that the optical module 100 passes a vibration test and an impact test defined in the Telcordia GR-468-CORE specification.

Dimensions of main components of the above-described optical module 100 may be as follows, for example. The upper case 109 may have a dimension of 177×123×17 mm, the printed circuit board 103 may have a dimension of 172×118×1.8 mm, and the outer dimension of the metal thin plate 102 is substantially identical to the dimension of the footprint of the optical receiving module 101, that is, the metal thin plate 102 may have an substantially identical shape to the lower surface shape of the optical receiving module 101, may be made of SUS304, and may have a thickness of 0.15 mm. Conditions to be satisfied by the thickness of the metal thin plate 102 will be hereinafter described.

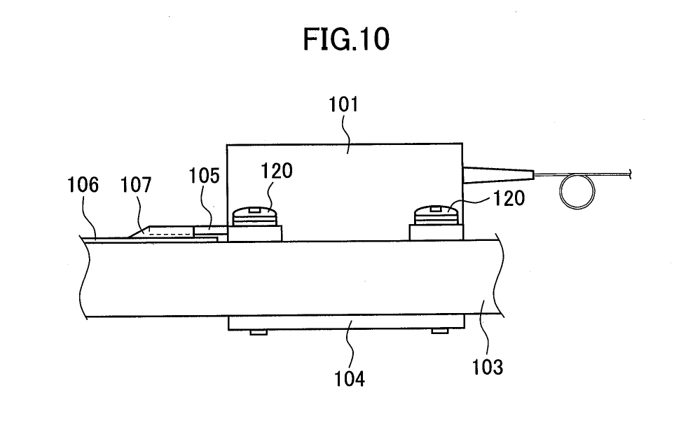

First, a problem that occurs when the metal thin plate 102 is not provided will be described. For example, a configuration example in a case where the optical receiving module 101 is directly provided on the printed circuit board 103 without providing the metal thin plate 102 in the optical module 100 according to the first embodiment is illustrated in FIG. 10.

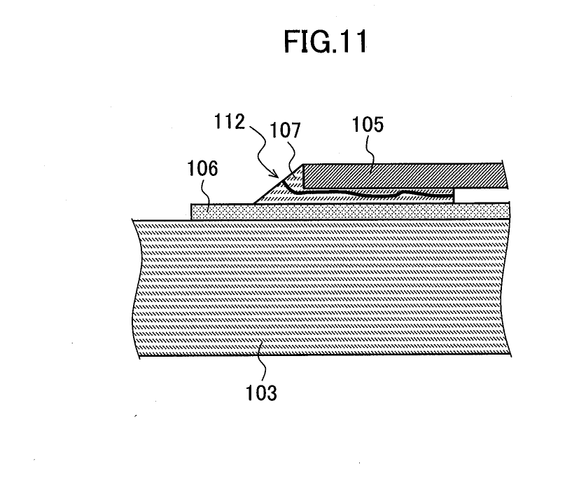

Since the distance between the leads 105 and the pad 106 is very small as illustrated in FIG. 10, lead connecting solder 107 has a portion having a very small thickness. In this case, when the optical module 100 having the configuration illustrated in FIG. 10 is subjected to a temperature cycling test, a significant deterioration of a high-frequency signal occurred before 100 cycles of the temperature cycling test. At this time, occurrence of crack was confirmed over the outer periphery of the lead connecting solder 107. In addition, when the lead connecting solder 107 after cross-section polishing was observed, it was confirmed that a crack 112 separating the whole of the lead connecting solder 107 existed therein, and the lead connecting solder 107 was completely fractured as illustrated in FIG. 11. Thus, it was determined that when the thickness of the lead connecting solder 107 is small, a crack occurs in the lead connecting solder 107 by the temperature cycling test, which causes a significant deterioration of a high-frequency signal as a result.

Note that, in the Telcordia GR-468-CORE as industry standard regarding reliability of optical module equipment generally used for communications, the condition of acceptance is defined that no characteristic degradation is caused after 100 cycles of −40° C/85° C. (holding time 30 min/30 min) in the temperature cycling test.

In the optical module 100 according to this embodiment, in order to increase the thickness of the lead connecting solder 107, the metal thin plate 102 made of stainless steel is inserted between the receiving module 101 and the printed circuit board 103, for example, so as to increase the distance between the lead portion of the receiving module and the pad, thereby increasing the thickness of the lead connecting solder 107.

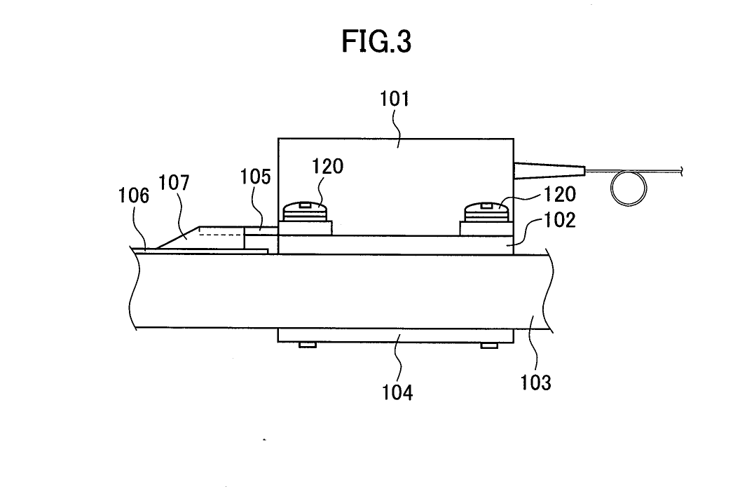

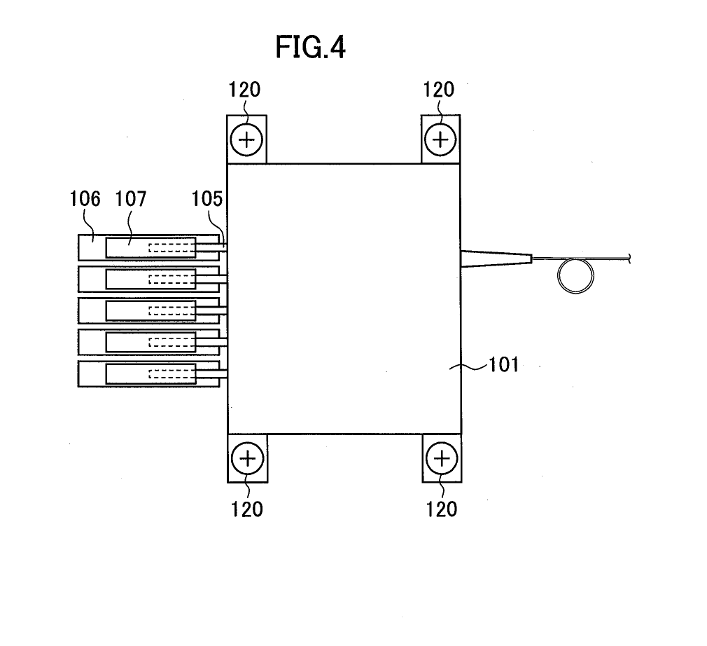

FIG. 3 illustrates a side view of the optical receiving module 101 according to the first embodiment with the metal thin plate 102 inserted, and FIG. 4 illustrates a plan view of the optical receiving module 101.

It can be seen that the distance between the leads 105 and the pad 106 is increased by inserting the metal thin plate 102 between the optical receiving module 101 and the printed circuit board 103 as illustrated in FIG. 3 comparing to the case of the optical module 100 illustrated in FIG. 10. It can be also seen that the thickness of the lead connecting solder 107 connecting the leads 105 and the pad 106 is thus increased. Note that in the example illustrated in FIG. 3, the thickness of the metal thin plate 102 is emphasized for description, but the actual thickness of the metal thin plate 102 may be different from the aspect illustrated in the drawing. Note that the thickness of the leads 105 is about 0.1 mm, for example, and (the lower side of) the leads 105 may be provided at a position at a distance of 0 to 200 μm, for example, from the bottom surface on the side surface of the optical receiving module 101.

As illustrated in FIG. 4, the number of the leads 105 is five, and the lead connecting solder 107 is required not to connect with adjacent ones of the leads 105. Note that the lead pitch (interval) of the leads 105 is about 1 mm, for example.

Next, the thickness of the metal thin plate 102 inserted between the optical receiving module 101 and the printed circuit board 103 will be described. The preferable range of the thickness of the metal thin plate 102 (the thickness of the lead connecting solder 107) will be hereinafter described from the standpoint of lifetime cycle in the temperature cycling test and the standpoint of the effect on the transmission characteristics of a high-frequency signal.

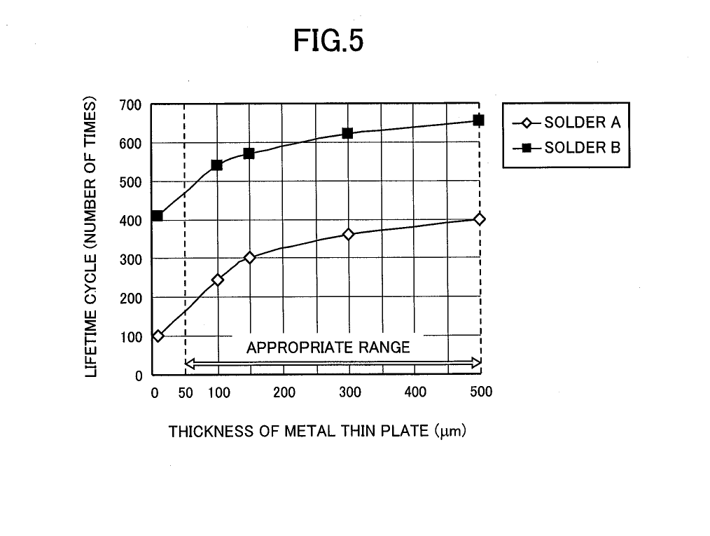

First, FIG. 5 shows a relationship between the thickness (μm) of the metal thin plate 102 and the lifetime cycle (number of times) in the temperature cycling test, the metal thin plate 102 being inserted between the optical receiving module 101 and the printed circuit board 103. The relationship shown in FIG. 5 is generated based on the result of the temperature cycling test of −40° C./85° C. (holding time 30 min/30 min) performed on the optical module 100 according to Telcordia GR-468-CORE while the thickness of the metal thin plate 102 varies from 50 μm to 500 μm. In FIG. 5, solder A is solder having a metal composition of Sn-3Ag-0.5Cu that is typical for Pb free solder, and solder B is solder having Sn—Ag—Cu—Sb composition that has an improved thermal fatigue resistance comparing to solder A.

As can be seen from FIG. 5, the lifetime of the lead connecting solder 107 of the optical receiving module 101 tends to be longer when the thickness of the metal thin plate 102 is larger. It is now clear that when the thickness of the metal thin plate 102 is 50 μm or more, the temperature cycle lifetime of both of solder A and B is more than 150 cycles (factor of safety: 1.5) having a margin with respect to 100 cycles of the above-described temperature cycle specification, for example. In addition, in order to secure the factor of safety to be larger than two, the thickness of the metal thin plate 102 should be 100 μm or more.

On the other hand, since the leads 105 of the optical receiving module 101 are thin to have the thickness of about 0.1 mm as illustrated in FIG. 3, when the thickness of the metal thin plate 102 increases and the raised height of the optical receiving module 101 increases, the leads 105 bend upon soldering using a general soldering iron, which may make the thickness of the solder smaller than the raised height. At this time, the leads bend parallel to the lead longitudinal direction and in the height direction, the thickness of the solder is partially thin. If the percentage of the thin part is 30% or less of the solder connection length, lifetime of the solder connection is not significantly affected.

Since the pitch interval of the leads 105 is about 1 mm and small, when the raised height of the optical receiving module 101 due to the metal thin plate 102 is more than 500 μm, the leads easily bend in a transverse direction (direction toward an adjacent lead) to cause a defect that solder bridges with the adjacent lead. Thus, the thickness of the metal thin plate 102 is preferably 500 μm or less.

As described above, the preferable thickness of the metal thin plate 102 from the standpoint of the lifetime cycle in the temperature cycling test is 50 to 500 μm.

As shown in FIG. 5, the lifetime cycle can be longer when solder B is used comparing to the case where solder A is used, but when solder B is used, the appropriate range of the thickness of the metal thin plate 102 is 100 μm or more in order to satisfy the condition of acceptance of a lifetime provision: 500 cycles of −40° C./85° C. (holding time 30 min/30 min) that is more strict than a use temperature condition defined in Telcordia GR-468-CORE, for example. In addition, because the appropriate range for a process by a soldering iron is 500 μm or less similarly to solder A, in order to satisfy the condition that the lifetime cycle is 500, the appropriate range of the thickness of the metal thin plate 102 when solder B is used is 100 to 500 μm.

Next, the appropriate range of the thickness of the metal thin plate 102 will be described from the standpoint based on the transmission characteristics of a high-frequency signal of the optical receiving module 101. This is because too large thickness of the metal thin plate 102 may deteriorate the transmission characteristics of a high-frequency signal.

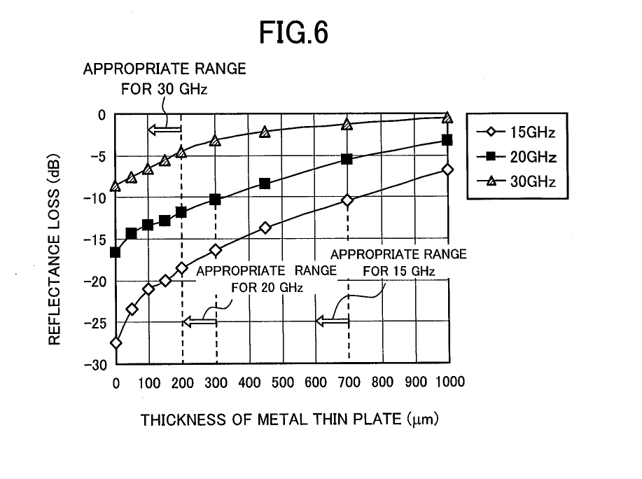

FIG. 6 shows the relationship between the thickness (μm) of the metal thin plate 102 and the reflectance loss (dB) of the high-frequency transmission characteristics of the optical receiving module 101 in the optical module 100 according to the first embodiment. The result shown in FIG. 6 is obtained by a high-frequency simulation with an assumption that the thickness of the metal thin plate 102 is the representative size of the lead connecting solder 107. Note that in FIG. 6, the thickness of the metal thin plate 102 is on the horizontal axis, and the reflectance loss SDD22 as an index of the high-frequency transmission characteristics is on the vertical axis, and the respective results when the signal frequency is 15 GHz, 20 GHz, and 30 GHz (signal transmission speed is 30 Gbit/sec, 40 Gbit/sec, 60 Gbit/sec, respectively) are shown. For stable signal transmission, the reflectance loss is usually evaluated for at least twice the range of the signal transmission speed.

As shown in FIG. 6, in the signal frequency range 0 to 15 GHz (signal transmission speed: 0 to 15 Gbit/sec), when the allowable value of the reflectance loss is set to be -10 dB or less, the allowable range of the thickness of the metal thin plate 102 is 700 μm or less. In the signal frequency range of to 20 GHz (signal transmission speed: 0 to 40 Gbit/sec), when the allowable value of the reflectance loss is set to be −10 dB or less, the allowable range of the thickness of the metal thin plate 102 is 300 μm or less. In the signal frequency range of 0 to 30 GHz (signal transmission speed: 0 to 60 Gbit/sec), when the allowable value of the reflectance loss is set to be −5 dB or less, the allowable range of the thickness of the metal thin plate 102 is 200 μm or less. As described above, according to the frequency range that is used by the optical receiving module 101, the allowable range of the thickness of the metal thin plate 102 varies.

For example, when solder A is used as a material of the lead connecting solder 107 under conditions that the frequency range of the optical receiving module 101 is 0 to 15 GHz and the reflectance loss is −10 dB or less, the appropriate range of the thickness of the metal thin plate 102 is 50 to 500 When solder A is used as a material of the lead connecting solder 107 under conditions that the frequency range of the optical receiving module 101 is 0 to 20 GHz and the reflectance loss is -10 dB or less, the appropriate range of the thickness of the metal thin plate 102 is 50 to 300 μm. When solder A is used as a material of the lead connecting solder 107 under conditions that the frequency range of the optical receiving module 101 is 0 to 30 GHz and the reflectance loss is −5 dB or less, the appropriate range of the thickness of the metal thin plate 102 is 50 to 200 μm.

For example, when the frequency range of the optical receiving module 101 is 0 to 15 GHz in the first embodiment, the thickness of the metal thin plate 102 inserted between the optical receiving module 101 and the printed circuit board 103 may be 150 μm. In addition, in order to improve the heat dispersion from the optical receiving module 101 to the printed circuit board 103, SUS304 may be used as a material of the metal thin plate 102, or a material obtained by Ni-plating on a Cu material having a higher thermal conductivity may be used. In addition, the metal thin plate 102 is slightly warped or waved. When the optical receiving module 101 is fastened by screws to the printed circuit board 103, it is desirable that an air layer is not formed when possible.

### Second Embodiment

Next, a second embodiment of the present invention will be described. In the second embodiment, the surface of a printed circuit board 103 on which the optical receiving module 101 is positioned is lower than the remaining surface, and the leads 105 are provided at higher positions than the bottom surface of the optical receiving module 101. This is the only difference from the first embodiment, and other than the point, the second embodiment is identical to the first embodiment, and thus description for respective parts of the optical module 100 will not be repeated.

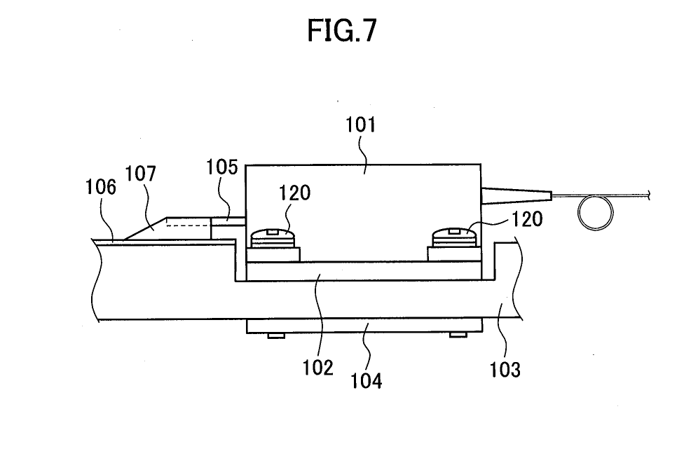

In FIG. 7, a side view of the optical module 100 according to the second embodiment is illustrated. As described above, the leads transmitting a high-frequency signal is provided in the middle of the optical receiving module 101 package in the second embodiment.

Also in the optical module 100 according to the second embodiment, it is possible not to deteriorate the transmission characteristics of a high-frequency signal by inserting the metal thin plate 102 between the optical receiving module 101 and the printed circuit board 103 and by setting the thickness of the lead connecting solder 107 connecting the leads 105 and the pad 106 in the range of 50 to 500 μm, for example (may obviously vary in the range of 50 to 500 μm depending on conditions similarly to the first embodiment) similarly to the optical module 100 according to the first embodiment.

### Third Embodiment

Next, a third embodiment of the present invention will be described. In the third embodiment, the positions of the flange portions used for fastening the optical receiving module 101 by screws are different from the first embodiment, but other than the point, the third embodiment is identical to the first embodiment, and thus description for respective parts of the optical module 100 will not be repeated.

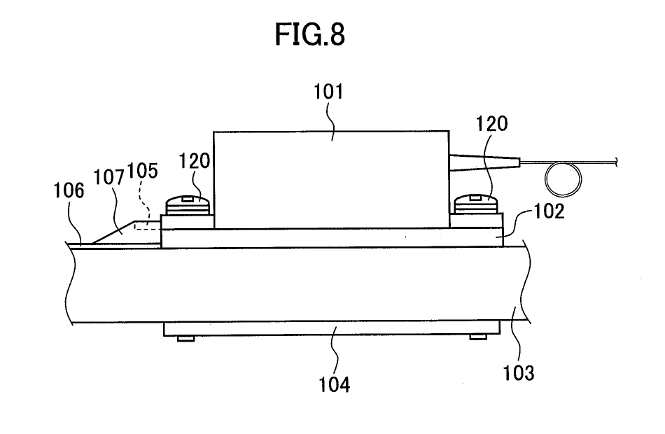

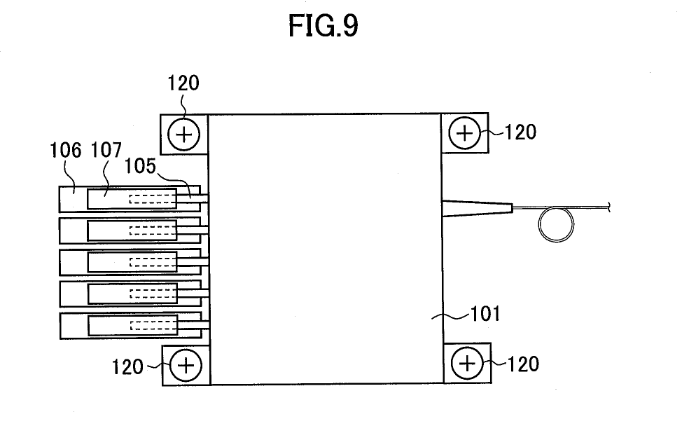

FIG. 8 illustrates a side view of the optical module 100 according to the third embodiment, and FIG. 9 illustrates a plan view of the optical module 100 according to the third embodiment. As illustrated in FIGS. 8 and 9, the third embodiment has a configuration where the flange portions used for fastening the optical receiving module 101 by screws stick out in the direction of the leads 105 that transmit a high-frequency signal. When the flange portions are provided on the side of the leads 105 that transmit a high-frequency signal, a stress applied to solder portions upon the temperature cycling test tends to be lower.

Also in the optical module 100 according to the third embodiment, it is possible not to deteriorate the transmission characteristics of a high-frequency signal by inserting the metal thin plate 102 between the optical receiving module 101 and the printed circuit board 103 and by setting the thickness of the lead connecting solder 107 connecting the leads 105 and the pad 106 in the range of 50 to 500 for example (may obviously vary in the range of 50 to 500 μm depending on conditions similarly to the first embodiment) similarly to the optical module 100 according to the first embodiment.

In the optical module 100 of the first to third embodiments according to the present invention as described above, the metal thin plate 102 is provided between the optical receiving module 101 and the printed circuit board 103, and the thickness of the lead connecting solder that connects the leads of the optical receiving module 101 and the pad of the printed circuit board 103 is adjusted to be in the appropriate range (50 to 500 μm, for example), whereby it is possible that the optical module 100 is tolerant to the temperature cycling test and the high-frequency transmission characteristics do not deteriorate.

### [Variation]

The present invention is not limited to the above-described embodiments. For example, in the above-described embodiments, the metal thin plate 102 is formed by one plate having a shape that fits with the shape of the lower surface of the optical receiving module 101, but the metal thin plate 102 may be divided into a plurality of plates and configured by the plurality of plates.

In addition, for the present invention, various modifications, variations and replacements are possible by those ordinarily skilled in the art as a matter of course.

What is claimed is:

1. An optical module, comprising:
an optical receiving module provided with a plurality of leads for transmitting an electrical signal at 15 Gbit/s or more;
a printed circuit board provided with a pad that is connected with the plurality of leads by solder; and
a metal thin plate that is provided between the printed circuit board and the optical receiving module when the optical receiving module is mounted on the printed circuit board, wherein
a thickness of the metal thin plate is defined in such a manner that a distance between the plurality of leads and the pad is in the range of 50 to 500 μm after the optical receiving module is mounted on the printed circuit board.

2. The optical module according to claim 1, wherein
the printed circuit board, the metal thin plate, and the optical receiving module are fastened by a plurality of screws that are inserted through the printed circuit board, the metal thin plate, and the optical receiving module respectively, and the plurality of leads and the pad are thereafter connected by the solder.

3. The optical module according to claim 1, wherein
the metal thin plate has a surface of a shape that is substantially identical to a surface of the optical receiving module, the surfaces facing each other.

4. The optical module according to claim 1, wherein
the metal thin plate is made of stainless steel.

5. The optical module according to claim 1, wherein
the plurality of leads is provided near a bottom surface of the optical receiving module on a side surface thereof, and
an area where the optical receiving module is mounted in the printed circuit board and the pad are in an identical surface.

6. The optical module according to claim 1, wherein
the optical receiving module includes the plurality of leads that transmit an electrical signal at 20 Gbit/s or more, and
the thickness of the metal thin plate is defined in such a manner that a distance between the plurality of leads and the pad is 50 to 300 μm when the optical receiving module is mounted on the printed circuit board.

7. The optical module according to claim 1, wherein
the optical receiving module includes the plurality of leads that transmit an electrical signal at 30 Gbit/s or more, and
the thickness of the metal thin plate is defined in such a manner that a distance between the plurality of leads and the pad is 50 to 200 μm when the optical receiving module is mounted on the printed circuit board.
